(19) United States
(12) Patent Application Publication
(10) Pub. No.: US 2014/0000323 A1
(43) Pub. Date: Jan. 2, 2014

(54) Security Hook for Product Display

(71) Applicant: Joseph F. Kologe, Scranton, PA (US)

(72) Inventor: Joseph F. Kologe, Scranton, PA (US)

(21) Appl. No.: 14/016,920

(22) Filed: Sep. 3, 2013

Related U.S. Application Data
(63) Continuation of application No. 13/281,800, filed on Oct. 26, 2011.

(51) Int. Cl. A47F 5/08; E05B 73/00

(52) U.S. Cl. CPC A47F 5/0861; E05B 73/0017
USPC 70/58

(57) ABSTRACT

A security product display hook assembly comprising a unique form of product display hook providing optimal levels of product security and customer convenience. The display hook has an upper arm and a lower, merchandise supporting arm formed with a back section, an intermediate section and a front section. The intermediate section is of sharply irregular configuration to allow, but inhibit, product removal, while effectively preventing mass product removal often attempted by shoplifters. The front section, which can support a product for display, includes a portion bent at right angles and in a plane at an angle to that of the configuration of the intermediate section, forming a product stop and requiring product removal in a transverse direction to the primary orientation of the hook assembly. A locking device can be mounted on an upper arm of the hook assembly for engagement with the lower arm at various locations.

### FIELD OF THE INVENTION

The present invention relates to product display hooks for suspending and displaying merchandise, and more particularly to such display hooks provided with security features to limit or prevent product theft.

### BACKGROUND OF THE INVENTION

Carded and packaged items of merchandise are commonly displayed on peg hooks and the like, referred to herein as product display hooks, which extend from metal bars, perforated panels, slat boards and the like. A number of like product items can be suspended and displayed from a single hook, and a large number of hooks can be mounted on a single panel, which makes such hooks a convenient and attractive way for storekeepers to offer their merchandise. An advantageous form of display hook is formed of wire and is provided with upper and lower outwardly extending arms. The upper arm mounts a label holder for pricing and other product information, while the lower arm receives the merchandise, typically mounted on cards with openings to receive the projecting wire of the display hook.

A potential downside to this manner of display, however, is that the merchandise so displayed can be targeted by shoplifters. Particularly when the displayed merchandise is of an expensive nature (packages of several dry cell batteries is one example) shoplifting can be a problem and a source of considerable economic loss to the shopkeeper.

Various concepts have been proposed to minimize product “shrinkage” from theft. Among these are specially designed product display hooks incorporating built-in locking arrangements. These tend to be expensive and also can make for a somewhat unattractive display. One widely used system is based on U.S. Pat. No. 6,957,555, which is directed to a special locking device that can be retrofitted onto a standard product display hook and prevents the unauthorized removal of merchandise from the hook. This product is made available by the assignee of this application under the trademark “ScanLock” and provides a convenient and economical means for preventing theft. The ScanLock device can be easily applied to and removed from standard hooks and thus provides the storekeeper with a great deal of flexibility in the display of merchandise. When a particular hook is to be loaded with expensive merchandise, the storekeeper can simultaneously install a ScanLock device, which requires a store clerk to attend the removal of the product. The locking device can later be quickly uninstalled from a hook if it is decided to display lower cost merchandise less subject to theft.

Unfortunately, the existing anti-theft solutions are in the nature of one-size-fits-all, in that either all of the merchandise on the hook is locked, or none of it is locked. However, not all store locations are subject to the same level of shoplifting risk, and for locations in lower risk areas storekeepers are interested in balancing risk of loss with shopper convenience. An improved system is needed, and is provided by this invention, whereby a storekeeper can elect to display a portion of the merchandise on a display hook in a locked and secure manner, while at the same time displaying one or a few items at the front, unlocked, for convenient access customers. Merchandise displayed in this manner is not highly attractive to shoplifters because of the limited number of unsecured items available, while providing normal convenience to the regular shopper.

### SUMMARY OF THE INVENTION

The invention is directed to a unique and advantageous form of product display hook which can be combined with a ScanLock device or other suitable form of locking device and which is so constructed that the product supporting lower arm comprises distinct back, intermediate and front sections. Merchandise can be placed and distributed on some or all of these distinct sections, and a locking device can be located on the front section, just behind the intermediate section, or at the back of the back section, depending on the levels of security and customer convenience deemed appropriate by the storekeeper. The intermediate section is of sharply irregular configuration, such that merchandise can be removed therefrom on a one-at-a-time basis, but not several at a time, to make the display less attractive to shoplifters.

### BRIEF DESCRIPTION OF THE DRAWINGS

FIG. 1 is a side elevational view of a product display hook incorporating features of the invention.

FIG. 2 is a front elevational view of the display hook of FIG. 1

FIG. 3 is a front elevational view of an advantageous form of locking device which can be utilized in combination with the display hook of FIG. 1.

FIG. 4-6 are side elevational views of the display hook of FIG. 1, shown with the locking device of FIG. 3 in various alternative positions, providing various degrees of security according to the desires of the storekeeper.

### DETAILED DESCRIPTION OF THE INVENTION

Referring to the drawings, the reference numeral 20 designates generally a display hook according to the invention. The display hook comprises a base plate 21, which can be of a known, conventional type, adapted to be supported on a display wall (not shown) of conventional type. The illustrated base plate is intended to be suspended on a metal cross bar (not shown). However, the base plate may also be configured for mounting on a perforated panel, slat board or other display panel arrangement. The illustrated base plate, designed for support on a metal cross bar, advantageously is provided with a through opening 22 at the bottom, for the reception of a locking pin 23 which extends under the bar and inhibits lifting of the hook off of the cross bar by unauthorized parties.

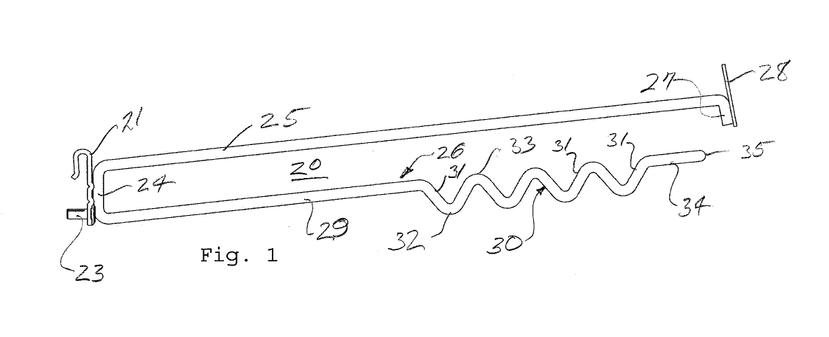

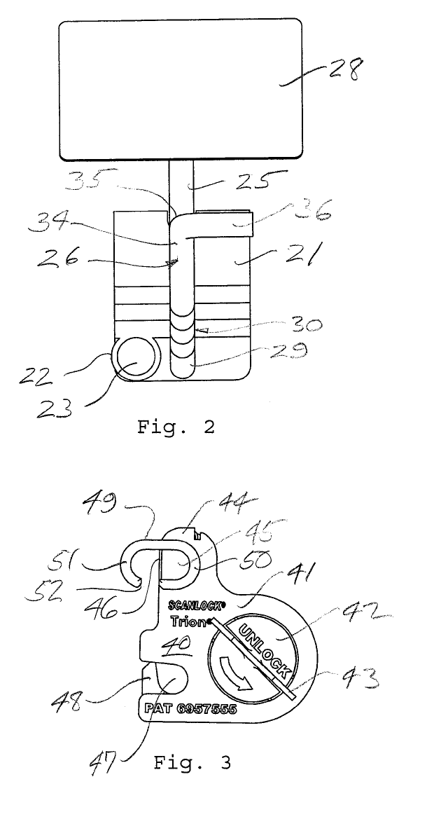

The main portion of the display hook 20 is formed of a continuous length of wire and comprises a vertical portion 24, which is welded or otherwise fixed to the base plate 21, an outwardly extending upper arm 25 and an outwardly extending lower arm 26 which extends generally parallel to but spaced below the upper arm, as shown in FIG. 1. In the illustrated form of the invention, the upper arm 25 of formed with a downwardly extending portion 27 at its forward extremity, and a label mounting plate 28 is welded to the portion 27. The mounting plate provides a fixed surface for securing labels with pricing and other product information. Alternative label mounting arrangements may be employed, such as pivoting label holders supported on a cross bar at the end of the upper arm 25. Whatever arrangement is provided for the display of labels will also serve the functions of protecting the outer end of the arm 25 and, when a locking device is mounted on the upper arm, of forming a positive stop means at the outer end of the arm.

In accordance with an aspect of the invention, the lower arm 26 of the display hook is formed with three separate sections. A first or back section 29 extends from the base plate 21 for approximately one-half the length of the lower arm, and is of relatively straight configuration such that carded or other merchandise suspended thereon can easily slide along the first section. A second or intermediate section 30 is integrally joined with the first section 29 and extends to a position a short distance from the end extremity of the lower arm 26. The intermediate section 30 is configured in a sharply angular form. In the illustrated example, the angular form consists of a plurality of connected V-shaped segments 31. The V-shaped segments 31 preferably are formed with sharp connecting curves 32, 33 at the bottom and top. In the illustrated example, the intermediate section 30 is formed with four sets of connected V-shaped segments 31.

Preferably, the V-shaped segments are aligned in a common vertical plane with the upper arm 25. The arrangement is such that, to remove an item of carded merchandise from the back section 29 of the lower hook, the item has to be moved vertically upward and downward four times in order for it to pass over the intermediate section 30 of the lower arm. This slows down the removal of the merchandise item and thus inhibits a “quick strike” action of a shoplifter. Moreover, the several connected V-shaped sections make it next to impossible for a shoplifter to strip a display hook of its entire inventory.

In the illustrated embodiment of the invention, the lower arm 26 also includes a forward section 34 joined integrally with the intermediate section 30 and extending forwardly therefrom to a point a short distance behind the label mounting plate 28. The forward section 34 desirably is straight and substantially coaxial with the back section 29. At its forward extremity 35, the forward section 34 has a lateral extension 36 that serves as a position stop for an item of merchandise at a forwardmost position on the lower arm while enabling the merchandise to be removed from the hook by a lateral motion along the extension.

Pursuant to an aspect of the invention, the illustrated display hook 20 is advantageously used in combination with a locking device 40, which preferably but not necessarily is of the type which forms the subject matter of the before mentioned U.S. Pat. No. 6,957,555, the subject matter of which is incorporated herein by reference. The described locking device comprises a body 41 containing a rotor element 42 that can be rotated between “lock” and “unlock” positions by an insertable/removable key 43. The upper portion 44 of the lock body 41 has a recess 45 for engaging the upper arm 25 of the hook, and a retaining plate 46 which secures the lock body to the upper arm 25 while allowing it to rotate about the arm.

As shown in FIG. 3, the lock body 41 includes a second recess 47 positioned to receive the back or forward sections 29, 34 of the hook 20 when the lock body is rotated to a position in which the lower recess 47 is directly below the upper recess 45. The lock rotor 42 includes a locking arm 48 which, when the rotor is in its “lock” position, closes off the recess 47 and secures the lock body 41 to the lower arm 26 of the display hook. When the lock body is secured to the lower arm, any merchandise suspended on the lower arm and positioned behind the lock body will be locked on the display hook. The lock can be released by rotation of the rotor to open the recess 47 and allow the lock body to be rotated out of the way. This, of course, requires the presence of an authorized person with a key.

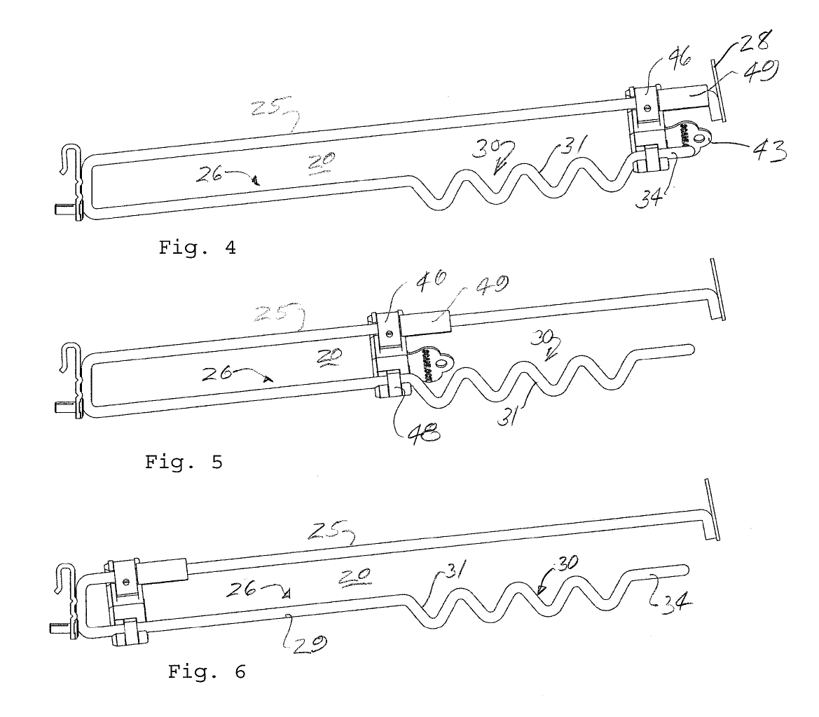

In the form of locking device 40 shown, the upper portion of the lock body is advantageously formed with an integral tubular extension 49. One portion 50 of the extension is aligned with the upper recess 45 and is arranged to receive a portion of the upper arm 25 when the lock body is mounted on the arm. A second portion 51 of the extension is positioned laterally beyond the open side of the recess 45 and has a downwardly opening slot 52. The slot 52 can be flexed open to fit over the upper arm 25 on enable the lock body to be installed thereon. The length of the tubular extension is such as to define a desired forwardmost position of the lock body 41 at a distance back of the label mounting plate 28, as shown in FIG. 4, whereby the lock body engages the lower arm 26 directly in front of the V-shaped sections 31 of the lower arm intermediate section 30.

Advantageously, a locking device 40 can be located in various positions on the display hook 20, as determined by the storekeeper to be consistent with the level of shoplifting threat that exists at the particular store location. In an upscale area, in which shoplifting is a negligible threat, and/or where the value of the displayed merchandise is relatively low, the storekeeper has the option of locating the locking device 40 at a backmost position on the back section 29 of the hook, as shown in FIG. 6, such that none of the displayed merchandise is locked and the customers may freely serve themselves in the selection of merchandise. Should circumstances indicate a moderate, but not high, level of threat, the storekeeper may opt to position the locking device at the forward end of the back section 29, as shown in FIG. 5. In this position, all merchandise items supported on the back section 29 will be locked and can be removed only by or with the attendance of a authorized store person with a key. In this configuration, however, the storekeeper can place one or several product items in front of the lock, hanging in the V-shaped sections 31 of the intermediate section 30 and/or on the forward section 34. And items on the forward section 34 will, of course be easily removable, and items on the intermediate section will be removable, but less easily.

Should the storekeeper deem the threat of loss high or very high, he or she has the further option of positioning the locking device 40 on the front section 34 of the lower arm 26. In this lock position, the storekeeper can place all of the merchandise behind the lock, or optionally leave an item suspended from the section 34 in front of the lock. When the locking device is positioned on the forward section 34, the lateral extension 36 of the forward section serves as a positive stop and thus will prevent the lower portion of the locking device, when locked, from being pulled forwardly over the end of the forward section to release merchandise.

A storekeeper's objective is always to sell as much merchandise as possible, consistent with holding “shrinkage” from shoplifting at tolerable levels. The invention gives the storekeeper unique tools to optimize the balance of customer accommodation and freedom to chose, with maintaining a desirable level of control over product loss, through the combination of an advantageous display hook configuration in conjunction with the optional use of a positionable locking device. This enables as much merchandise as the store owner is willing to risk, given the store location and surrounding circumstances, to be made directly accessible to the customer, with the option to require the presence of store personnel to release any greater amount of the displayed product. The storekeeper's options apply to both the character of the surrounding neighborhood and to the value of the displayed merchandise, and both can be evaluated in the determination of an optimal location for placement of the locking device on a particular merchandise hook.

It will be understood, of course, that the embodiments of the invention herein specifically disclosed are intended to be representative of the invention but not limiting as to the manner in which it may be carried out. Accordingly, reference should be made to the following appended claims in determining the full scope of the invention.

What is claimed is:

1. A security product display hook assembly for the display and controlled dispensing of product items, which comprises
a base for mounting the hook on a display panel, and upper and lower arms formed of wire and extending outwardly from said base in vertically spaced relation,
said upper arm having a forward end with means thereon for supporting a product information label,
said lower arm having a generally straight back section, positioned adjacent to said base and adapted for the easily slidable reception of product items, an intermediate section of irregular configuration for accommodating and causing the obstructed removal of product items, and a forward section for removal and optional display of product items,
said forward section comprising a short straight portion extending forwardly from said intermediate section and a stop element integrally joined with a forward end of said short portion and disposed substantially at right angles thereto to serve as a product stop element and to require a product to be removed from said display hook in a direction transverse to said short portion.

2. A hook assembly according to claim 1, wherein,
said intermediate section comprises one or more vertically displaced portions of sharply angular form to obstruct the removal of product items from said lower arm, and
said stop element is disposed in a plane oriented substantially at right angles to a plane containing said vertically displaced portions.

3. A security product display hook assembly according to claim 1, wherein
said intermediate section of said lower arm comprises a plurality of angularly disposed alternately upwardly and downwardly disposed sections joined at an acute angle and disposed substantially in a common plane with said upper arm, whereby a series of upward and downward movements of a product item is required in order to transfer the product item from said inner section to said forward section of said lower arm.

4. A hook assembly according to claim 2, wherein,
said portions of sharply angular form comprises at least one section of V-shaped or inverted V-shaped configuration.

5. A hook assembly according to claim 4, wherein,
said at least one section of V-shaped or inverted V-shaped configuration comprises a plurality of sections of V-shaped configuration joined together by portions comprising sharp connecting curves.

6. A security product display hook assembly according to claim 1, wherein
a locking device is movably mounted on said upper arm and has a first operative position with a lower portion thereof secured to said forward section of said lower arm, a second operative position with said lower portion secured at a forward position on said back section of said lower arm, and a third operative position at a back position on said back section of said lower arm.
